(19) United States
(12) Patent Application Publication
(10) Pub. No.: US 2015/0105022 A1
(43) Pub. Date: Apr. 16, 2015

(54) MULTITASKING SYSTEM OF BLUETOOTH HEADSET

(71) Applicant: SENA TECHNOLOGIES INC., Seoul (KR)

(72) Inventor: Oh Jin Jung, Seoul (KR)

(73) Assignee: SENA TECHNOLOGIES INC., Seoul (KR)

(21) Appl. No.: 14/513,688

(22) Filed: Oct. 14, 2014

(30) Foreign Application Priority Data
Oct. 14, 2013 (KR) 10-2013-0122090

(51) Int. Cl. H04W 4/00

(52) U.S. Cl. CPC H04W 4/008
USPC 455/41.2

(57) ABSTRACT

A multitasking system of a Bluetooth headset, which enables users to talk with each other in a telephone call while at the same time enjoying media content played by an external Bluetooth device. The multitasking system of a Bluetooth headset includes: a first Bluetooth headset worn by a first user, and a second Bluetooth headset worn by a second user. The first Bluetooth headset is configured to include a first Bluetooth module, and a second Bluetooth module that is connected to the first Bluetooth module. The second Bluetooth headset is configured to include a third Bluetooth module that is paired with the first Bluetooth module, and a fourth Bluetooth module that is connected to the third Bluetooth module.

### CROSS-REFERENCE TO RELATED APPLICATION(S)

This application claims priority from Korean Patent Application No. 10-2013-0122090, filed on Oct. 14, 2013, in the Korean Intellectual Property Office, the entire disclosure of which is incorporated herein by reference for all purposes.

### BACKGROUND

1. Field

The following description relates to a multitasking system of a Bluetooth headset, which enables users to communicate with each other while enjoying media content played by an external Bluetooth device.

2. Description of the Related Art

Generally, it is an obligation for a driver to wear a helmet while driving a two-wheeled vehicle, such as a motorcycle or a bicycle, to protect a head and a face of a driver, and to prevent accidents.

However, talking on a mobile phone while wearing a helmet is uncomfortable, so a driver would take off a helmet to talk on the phone. Further, when a call is incoming on the mobile phone while driving, in order to prevent an accident since both hands are not free, a user needs to stop driving to talk on the mobile phone, which is inconvenient.

In order to resolve such inconvenience, a Bluetooth headset including a Bluetooth module is mounted in a helmet to allow wireless voice and data communication between devices.

As described above, by using a Bluetooth headset mounted in a helmet, users wearing the Bluetooth headset may communicate with each other, and may enjoy media content played by a navigation or a mobile phone with a Bluetooth function.

However, the conventional Bluetooth headset includes only one Bluetooth module therein, such that in a case where a plurality of Bluetooth devices are paired, it is required to increase time sharing speed in accordance with the number of paired Bluetooth modules, thereby causing interference.

As a result, there is a problem in that media content, which is being played through a Bluetooth device paired with a Bluetooth headset, stops playing when a call is incoming and users wearing Bluetooth headsets are talking with each other.

### SUMMARY

The present disclosure provides a multitasking system of a Bluetooth headset, which enables media content, which is being played by an external Bluetooth device, to be provided seamlessly at the same time users wearing Bluetooth headsets are talking with each other in a call.

In one general aspect, there is provided a multitasking system of a Bluetooth headset, the system including: a first Bluetooth headset worn by a first user, and configured to include a first Bluetooth module and a second Bluetooth module that is connected to the first Bluetooth module; and a second Bluetooth module worn by a second user, and configured to include a third Bluetooth module that is paired with the first Bluetooth module and a fourth Bluetooth module that is connected to the third Bluetooth module.

### BRIEF DESCRIPTION OF THE DRAWINGS

FIG. 1 is a block diagram illustrating an example of a multitasking system of a Bluetooth headset according to an exemplary embodiment.

FIG. 2 is a block diagram illustrating an example of controlling by a first Bluetooth headset in FIG. 1.

FIG. 3 is a diagram illustrating an example of a first Bluetooth headset for implementing a multitasking system of a Bluetooth headset in FIG. 1.

FIG. 4 is a block diagram illustrating another example of a multitasking system of a Bluetooth headset in FIG. 1.

FIG. 5 is a diagram illustrating an example of controlling by the first Bluetooth headset in FIG. 4.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

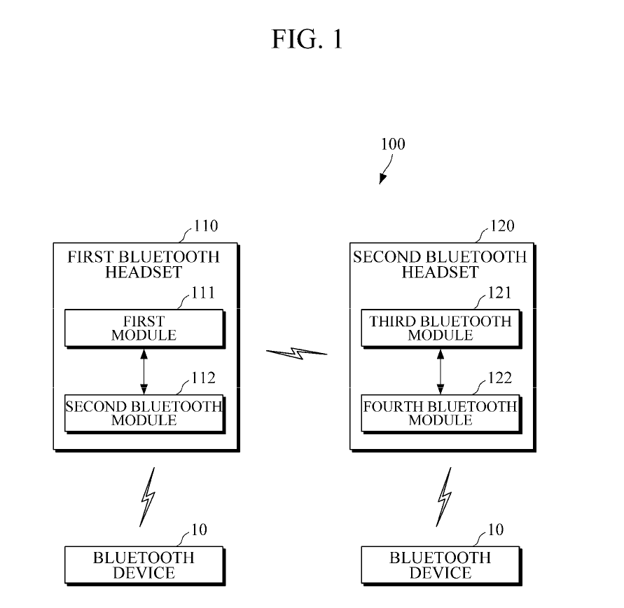

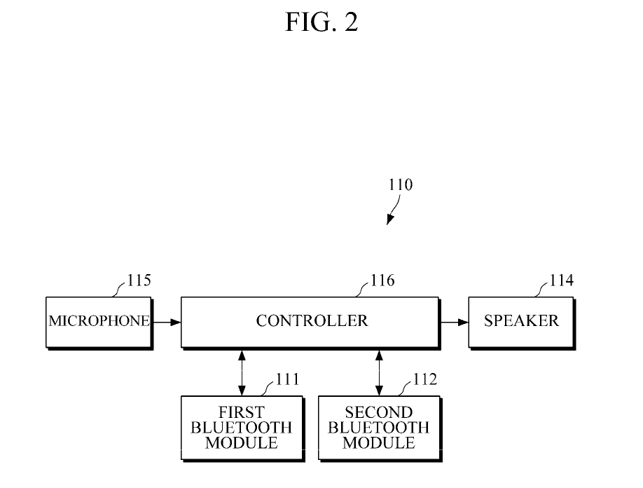

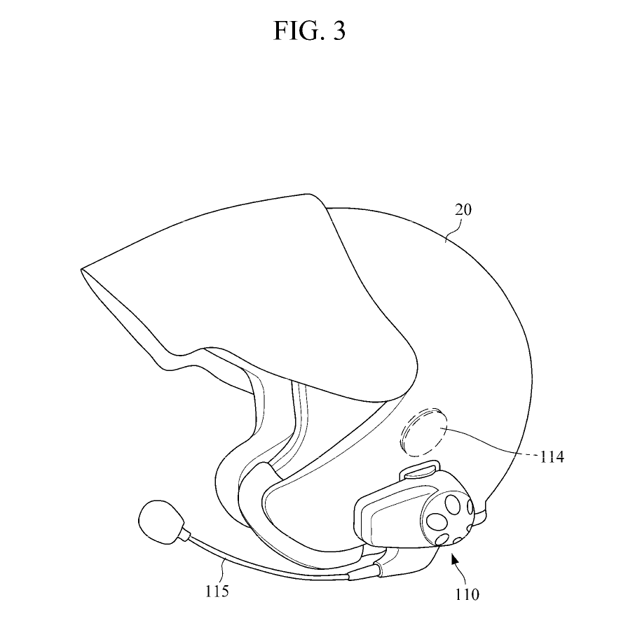

FIG. 1 is a block diagram illustrating an example of a multitasking system of a Bluetooth headset according to an exemplary embodiment. FIG. 2 is a block diagram illustrating an example of controlling by a first Bluetooth headset in FIG. 1. FIG. 3 is a diagram illustrating an example of a first Bluetooth headset for implementing a multitasking system of a Bluetooth headset in FIG. 1. The multitasking system 100 of a Bluetooth headset enables media content, which is being played by an external Bluetooth device, to be provided when a plurality of users are talking using their Bluetooth headsets.

As illustrated in FIGS. 1 to 3, the multitasking system 100 of a Bluetooth headset includes a first Bluetooth headset 110 and a second Bluetooth headset 120.

The first Bluetooth headset 110 is worn by a first user, and is configured to include a first Bluetooth module 111 and a second Bluetooth module 112 that is connected to the first Bluetooth module 111. Any one of the first Bluetooth module 111 and the second Bluetooth module 112 transmits speech data of the first user to the second Bluetooth headset 120, and the other Bluetooth module is paired with an external Bluetooth device 10 for a wireless communication.

For example, once the first Bluetooth module 111 of the first Bluetooth headset 110 is paired with the third Bluetooth module 121 of the second Bluetooth headset 120 to transmit speech data of the first user to a speaker built in the second Bluetooth headset 120, the second Bluetooth module 112 is paired with the external Bluetooth device 10 to receive speech data of media content played by the external Bluetooth device 10. Accordingly, media content played by the Bluetooth device 10 may be provided simultaneously while the first user is communicating with the second user.

The second Bluetooth headset 120 is worn by the second user, and is configured to include a third Bluetooth module 121 paired with the first Bluetooth module 111, and a fourth Bluetooth module 122 connected to the third Bluetooth module 121. Any one of the third Bluetooth module 121 and the fourth Bluetooth module 122 transmits speech data of the second user to the first Bluetooth headset 110, and the other Bluetooth module is paired with the external Bluetooth device 10 for a wireless communication.

For example, once the third Bluetooth module 121 of the second Bluetooth headset 120 and the first Bluetooth module 111 of the first Bluetooth headset 110 are paired to transmit speech data of the second user to a speaker 114 built in the first Bluetooth headset 110, the fourth Bluetooth module 122 is paired with the external Bluetooth device 10 to receive speech data of media content played by the Bluetooth device 10. Accordingly, the second user may be provided with media content by the Bluetooth device 10 while at the same time communicating with the first user.

In order to facilitate time sharing, the first Bluetooth module 111 and the second Bluetooth module 112 of the first Bluetooth headset 110 may be directly connected in a circuit, and the third Bluetooth module 121 and the fourth Bluetooth module 122 of the second Bluetooth headset 120 may be directly connected in a circuit.

If a number of paired Bluetooth modules increases, data transmission speed is required to be increased according to the increased number of paired Bluetooth modules, so that each module may maintain wireless connection. That is, as the number of paired Bluetooth modules increases, time sharing is required to be faster, thereby causing interference, such that connection among Bluetooth modules is difficult to be maintained, and is easily disconnected. As a result, it is appropriate to directly connect the first Bluetooth module 111 and the second Bluetooth module 112, and the third Bluetooth module 121 and the fourth Bluetooth module 122 in a circuit.

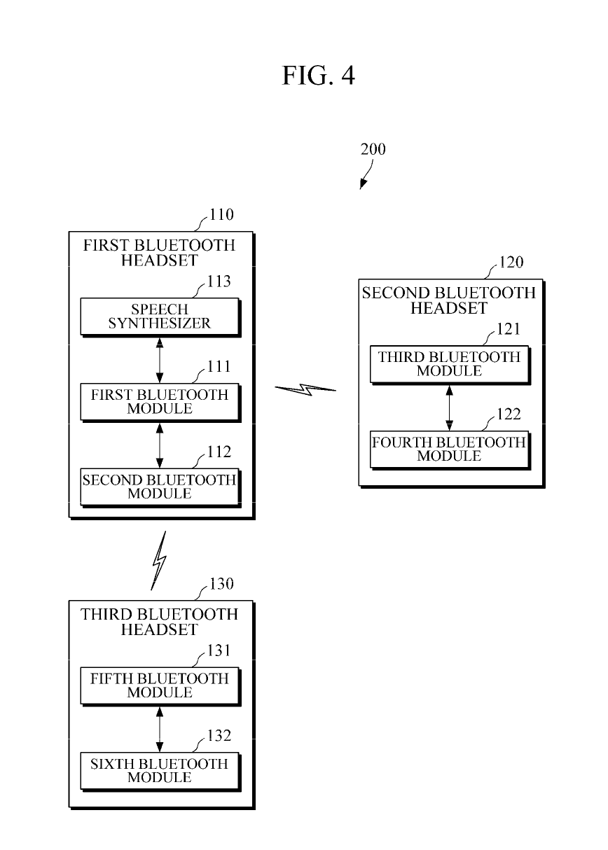

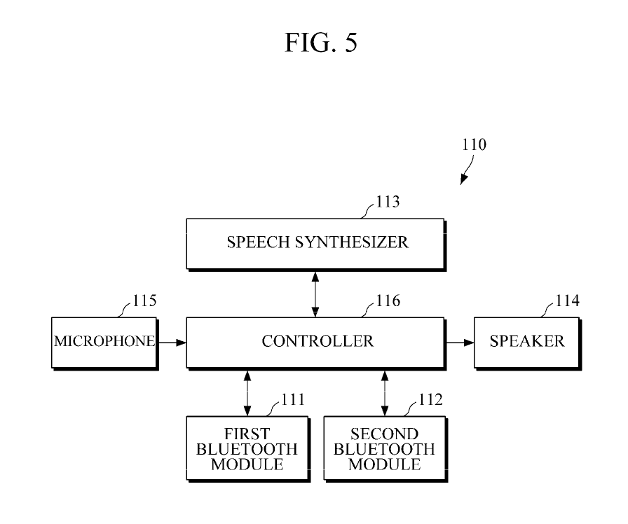

FIG. 4 is a block diagram illustrating another example of a multitasking system of a Bluetooth headset in FIG. 1. FIG. 5 is a diagram illustrating an example of controlling by the first Bluetooth headset in FIG. 4.

As illustrated in FIGS. 4 and 5, the multitasking system 200 of a Bluetooth headset may be configured to further include at least one third Bluetooth headset 130 worn by a third user. The third Bluetooth headset 130 may be configured to include a fifth Bluetooth module 131 paired with the first Bluetooth module 111, and a sixth Bluetooth module that is connected to the fifth Bluetooth module 131.

The first Bluetooth headset 110 may be configured to further include a speech synthesizer 113, which synthesizes speech data of a second user received from the second Bluetooth headset 120 and speech data input from the first user, to transmit the synthesized speech data to the third Bluetooth headset 130.

Once speech data of the first user and speech data of the second user are synthesized by the speech synthesizer 113, and the synthesized speech data is transmitted to the third Bluetooth headset 130, the third user wearing the third Bluetooth headset 130 may receive speech data transmitted and received between the first user and the second user, thereby enabling telephonic communication among a plurality of users.

The speech synthesizer 113 may include a digital signal processor (DSP). The DSP is a microprocessor that not only removes unnecessary sounds but also corrects sound distortions, and synthesizes necessary information by performing processes, such as filtering, Fourier conversion, or the like. The DSP has a processing speed that is 115 times faster than a normal microprocessor.

Hereinafter, operations of the multitasking system of Bluetooth headsets will be described with reference to FIGS. 1 to 5.

First, once the first Bluetooth module 111 of the first Bluetooth headset 110 is paired with the third Bluetooth module 121 of the second Bluetooth headset 120, speech data of the first user input from a microphone 115 of the first Bluetooth headset 110 is transmitted to a speaker of the second Bluetooth headset 120. In this case, speech data of the second user is also transmitted to the speaker 114 of the first Bluetooth headset 110, so that speech data may be transmitted and received between the first user and the second user.

Then, the second Bluetooth module 112 of the first Bluetooth headset 110, and the fourth Bluetooth module 122 of the second Bluetooth headset 120 are paired with each of the external Bluetooth devices 10 for wireless communication.

Accordingly, the first user wearing the first Bluetooth headset 110 and the second user wearing the second Bluetooth headset 120 may communicate wirelessly through the first Bluetooth module 111 and the third Bluetooth module 121. Further, at the same time, the first user and the second user may be provided with media content played by the external Bluetooth device 100 through the second Bluetooth module 112 and the fourth Bluetooth module 122.

That is, while the first user and the second user are talking with each other using Bluetooth headsets, they may be provided with media content played by the external Bluetooth device 10. In this case, the first Bluetooth module 111, the second Bluetooth module 112, the third Bluetooth module 121, and the fourth Bluetooth module 122 may be directly connected in a circuit to facilitate time sharing.

The multitasking system 200 of Bluetooth headsets is worn by the third user, and may be configured to further include the third Bluetooth headset 130 that includes a fifth Bluetooth module 131 paired with the first Bluetooth module 111, and a sixth Bluetooth module 132 that is connected to the fifth Bluetooth module 131.

Once the fifth Bluetooth module 131 of the third Bluetooth headset 130 is paired with the first Bluetooth module 111 of the first Bluetooth headset 110, the third user wearing the third Bluetooth headset 130 may also transmit and receive speech data to and from the first user. In this case, the first Bluetooth headset 110 may be configured to further include the speech synthesizer 113 to synthesize speech data of the first user and speech data of the second user and to transmit the synthesized speech data to the third Bluetooth headset 130.

As described above, once speech data of the first user and speech data of the second user are synthesized by the speech synthesizer 110, a controller 116 of the first Bluetooth headset 110 transmits the synthesized speech data to the first Bluetooth module 111, and then the first Bluetooth module 111 transmits the received speech data to the speaker 114 of the third Bluetooth headset 130. Accordingly, the third user wearing the third Bluetooth headset 130 may receive speech data transmitted and received between the first user and the second user, thereby enabling telephonic communication among a plurality of users.

The sixth Bluetooth module 132 of the third Bluetooth headset 130 is configured to be paired with the external Bluetooth device 10, such that the third user may be provided with media content played by the Bluetooth device 10, while at the same time communicating with the first user.

According to the present disclosure, two Bluetooth modules are provided in a Bluetooth headset, in which only one Bluetooth module is configured to be paired with each of the two modules, thereby seamlessly providing media content, which is being played by an external Bluetooth device, to users during a call.

Further, in a case where a first Bluetooth headset and two or more Bluetooth headsets are paired, a speech synthesizer is further provided in the first Bluetooth headset, in which speech data transmitted and received to and from a second user wearing a second Bluetooth headset is synthesized by the speech synthesizer, and the synthesized speech data is transmitted to a third user wearing a third Bluetooth headset, thereby enabling communication among a plurality of users.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multitasking system of a Bluetooth headset, the system comprising:
a first Bluetooth headset worn by a first user, and configured to include a first Bluetooth module and a second Bluetooth module that is connected to the first Bluetooth module; and
a second Bluetooth module worn by a second user, and configured to include a third Bluetooth module that is paired with the first Bluetooth module and a fourth Bluetooth module that is connected to the third Bluetooth module.

2. The system of claim 1, further comprising at least one third Bluetooth headset worn by a third user, and configured to include a fifth Bluetooth module that is paired with the first Bluetooth module and a sixth Bluetooth module that is connected to the fifth Bluetooth module.

3. The system of claim 2, wherein the first Bluetooth headset further comprises a speech synthesizer, which synthesizes speech data of the second user received from the second Bluetooth headset and speech data input from the first user, and transmits the synthesized speech data to the third Bluetooth headset.
